(19) United States
(12) Patent Application Publication
(10) Pub. No.: US 2021/0208302 A1
(43) Pub. Date: Jul. 8, 2021

(54) VISUALIZATION FOR LOOK-AHEAD INVERSION

(71) Applicant: HALLIBURTON ENERGY SERVICES,INC., Houston, TX (US)

(72) Inventors: Jin MA, Houston, TX (US); Clint P. LOZINSKY, Kingwood, TX (US); Nigel Mark CLEGG, Norwich (GB)

(73) Assignee: HALLIBURTON ENERGY SERVICES,INC., Houston, TX (US)

(21) Appl. No.: 16/734,029

(22) Filed: Jan. 3, 2020

(51) Int. Cl. G01V 3/38; G01V 3/34; G01V 3/28; E21B 47/12

(52) U.S. Cl. CPC G01V 3/38; E21B 47/122; G01V 3/28; G01V 3/34

(57) ABSTRACT

Data filtering and processing techniques for generating improved wellbore resistivity displays are contemplated. In some aspects, a process of the disclosed technology includes steps for receiving a first measurement set comprising electromagnetic field data for a first tool depth in a geologic formation, receiving a second measurement set comprising electromagnetic field data for a second tool depth in the geologic formation, performing an inversion on the first measurement set and the second measurement set to generate a first formation profile and a second formation profile, and displaying the first formation profile and the second formation profile in a user interface (UI). Systems and machine-readable media are also provided.

### TECHNICAL FIELD

The present disclosure pertains to formation evaluation and in particular, to the use of data learning and filtering methods to aid high-resolution profile generation to facilitate geo steering.

### BACKGROUND

In drilling wells for oil and gas exploration, understanding the structure and properties of the associated geological formation provides information to aid such exploration. The collection of information relating to formation properties and conditions downhole is commonly referred to as “logging,” and can be performed during the drilling process.

Various measurement tools exist for use in wireline logging and logging while drilling (LWD). One such tool is an electromagnetic (EM) resistivity tool. A typical resistivity tool includes one or more antennas for transmitting electromagnetic signals into the formation and one or more antennas for receiving a formation response. When operated at low frequencies, the resistivity tool may be called an “induction” tool, and at high-frequencies may be called an electromagnetic wave propagation tool. Though the physical phenomena that dominate the measurement can vary with frequency, the operating principles for the tool are consistent. In some cases, the amplitude and/or phase of the received signals are compared to the amplitude and/or phase of the transmitted signals to measure formation resistivity. In other cases, the amplitude and/or phase of the received signals are compared to each other to measure the formation resistivity.

When plotted as a function of depth or tool position in the borehole, the resistivity tool measurements are termed “logs” or “resistivity logs.” Such logs can provide indications of hydrocarbon concentrations and other information useful to drillers and completion engineers. In particular, azimuthally-sensitive logs can provide information useful for steering the drilling assembly e.g., to facilitate geosteering.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 is a schematic diagram of an example logging-while-drilling (LWD) environment.

FIG. 2 shows an illustrative resistivity logging tool that can be implemented in accordance with some inventive aspects of the disclosed technology.

FIG. 3 is a process for performing inversion map processing and providing look-ahead inversion visualization, according to some aspects of the disclosed technology.

FIG. 4 is an example of a conventional inversion map.

FIGS. 5A and 5B are examples of inversion map visualizations that utilize inclination arrows, according to some aspects of the disclosed technology.

FIGS. 6A and 6B are examples of inversion map visualizations that use tool graphics to indicate tool inclination, according to some aspects of the disclosed technology.

FIG. 7 is a schematic diagram of an example system embodiment.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Reservoir resistivity maps are frequently used by drillers and completion engineers to facilitate geosteering and enhance production. However, conventional resistivity maps do not provide visual indications of tool inclination and do not intuitively represent tool distances from formation boundaries. As used herein, formation boundaries are used to describe boundaries between geologic formation types, such as between non-hydrocarbon and hydrocarbon layers having different resistivity characteristics.

Aspects of the disclosed technology address the foregoing limitations of conventional resistivity inversion image generation by providing novel resistivity map visualizations. In some aspects, visualizations of the disclosed technology provide indications of tool distance from various formation boundaries with respect to time and/or depth. In such aspects, the visualizations can indicate current and objective layer distances, as well as boundary uncertainties. Additionally, as discussed in further detail below, visualizations of the disclosed technology can provide indications of tool inclination, for example, using either tool graphics or other visual indicators (e.g., arrows) to indicate an angle of tool inclination at different times and/or depths.

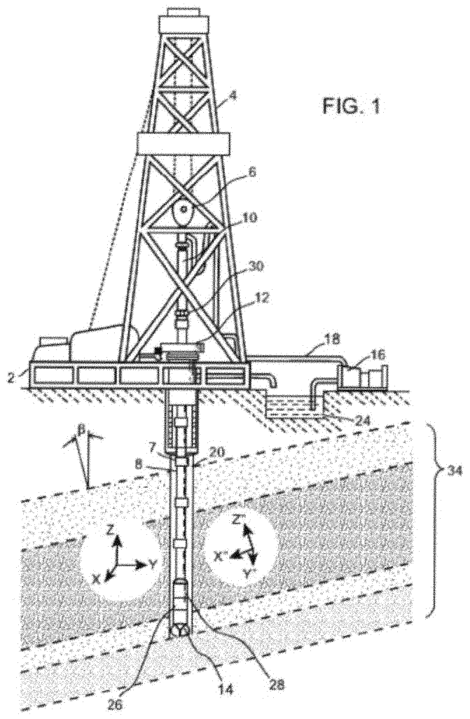

To illustrate a context for the disclosed systems and methods, FIG. 1 shows a well during drilling operations. A drilling platform 2 is equipped with a derrick 4 that supports a hoist 6. Drilling oil and gas wells is carried out by a string of drill pipes connected together by “tool” joints 7 so as to form a drill string 8. Hoist 6 suspends a kelly 10 that lowers the drill string 8. Hoist 6 suspends a kelly 10 that lowers the drill string 8 through rotary table 12. Connected to the lower end of the drill string 8 is a drill bit 14. Bit 14 is rotated and drilling accomplished by rotating the drill string 8 by use of a downhole motor near the drill bit, or by both methods.

Drilling fluid, termed “mud,” is pumped by mud recirculation equipment 16 through supply pipe 18, through drilling kelly 10, down through the drill string 8 at high pressures and volumes to emerge through nozzles or jets in the drill bit 14. The mud then travels back up the hole via the annulus formed between the exterior of drill string 8 and borehole wall 20, through a blowout preventer, and into a mud pit 24 on the surface. On the surface, the drilling mud is cleaned and then recirculated by recirculation equipment 16.

For logging while drilling (LWD), downhole sensors 26 are located in the drill string 8 near the drill bit 14. Sensors 26 include directional instrumentation and a modular resistivity tool with tilted antennas for detecting bed boundaries. The directional instrumentation measures the inclination angle, the horizontal angle, and the azimuthal angle (also known as the rotational or “tool face” angle) of the LWD tools. As is commonly defined in the art, the inclination angle is the deviation from vertically downward, the horizontal angle is the angle in a horizontal plane from true North, and the tool face angle is the orientation (rotational about the tool axis) angle from the high side of the wellbore.

In some embodiments, directional measurements are made as follows: a three-axis accelerometer measures the earth's gravitational field vector relative to the tool axis and a point on the circumference of the tool called the “tool face scribe line.” (The tool face scribe line is drawn on the tool surface is a line parallel to the tool axis.) From this measurement, the inclination and tool face angle of the LWD tool can be determined. Additionally, a three-axis magnetometer measures the earth's magnetic field vector in a similar manner. From the combined magnetometer and accelerometer data, the horizontal angle of the LWD tool can be determined. In addition, a gyroscope or other form of inertial sensor can be incorporated to perform position measurements and further refined orientation measurements.

In some embodiments, downhole sensors 26 are coupled to a telemetry transmitter 28 that transmits telemetry signals by modulating the mud flow in drill string 8. A telemetry receiver 30 is coupled to kelly 10 to receive transmitted telemetry signals. Other telemetry transmission techniques are well-known and may be used. The receiver 30 communicates the telemetry to a surface insulation (not shown) that processes and stores the measurements.

As illustrated in FIG. 1, the drill bit 14 is shown penetrating a formation having a series of layered beds 34 dipping at an angle. A first (x, y, z) coordinate system associated with the sensors 26 is shown, and a second coordinate system (x″, y″, z″) associated with the beds 32 is shown. The bed coordinate system has the z″ axis perpendicular to the bedding plane, has the y″ axis in a horizontal plane, and has the x″ axis pointing “downhill.” The angle between the z-axis of the two coordinate systems is referred to as the “dip” and is shown in FIG. 1 as the angle β.

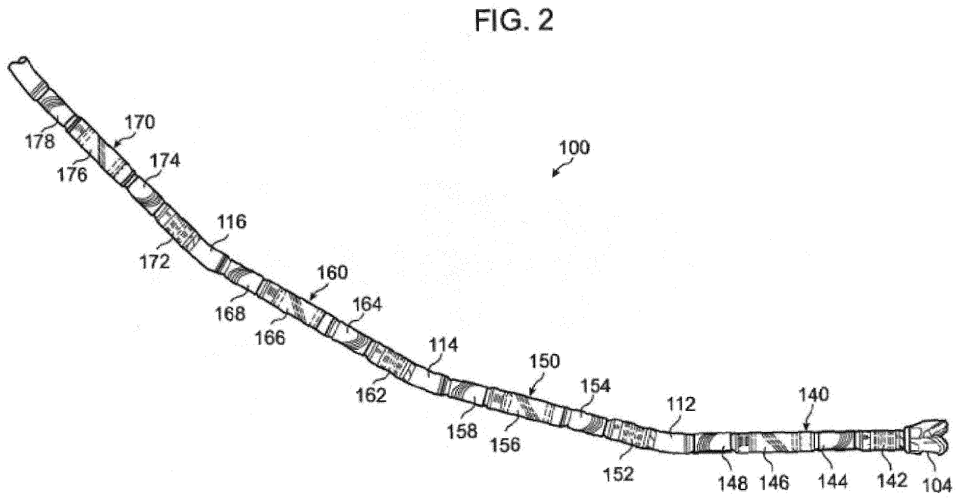

Referring now to FIG. 2, which depicts an example of a multi-sub resistivity tool 100. In the illustrated example, tool 100 comprises a set of four subs distributed along a curved borehole trajectory. The four subs include a first sub 140, a second sub 150, a third sub 160, and a fourth sub 170. A longitudinal axis of the first sub 140 is approximately horizontal with respect to the x-y plane. A drill bit 104 attaches to the lower end (relative to the bottom of the wellbore) to the first sub 140. A first coaxial coil antenna 142 wraps around the body of the first sub 140 near the lower end. The first sub 140 also includes a first tilted coil antenna 144 positioned adjacent to the first coaxial coil antenna 142. The first sub 140 includes a second tilted coil antenna 146 positioned adjacent to the first tilted coil antenna 144. The first sub 140 also includes a third tilted coil antenna 148 adjacent to the second tilted coil antenna 146. In some embodiments, each of the coil antennas 142-148 is operated as transmitter antenna. In other examples, each of the coil antennas 142-148 can be operated as either receiver or transmitter antenna.

A connecting tubular 112 attaches to the upper end (relative to the top of the wellbore) of the first sub 140. A second sub 150 attaches to the upper end of the connecting tubular 112. The second sub 150 is rotatable with respect to its longitudinal axis, and the longitudinal axis can be at an angle with respect to the longitudinal axis of the first sub 140. A first coaxial coil antenna 152 wraps around the lower-most side of the second sub 150. The second sub 150 also includes a first tilted coil antenna 154 positioned above and adjacent to the first coaxial coil antenna 152. The second sub 150 includes a second tilted coil antenna 156 positioned adjacent to the first tilted coil antenna 154. The second sub 150 also includes a third tilted coil antenna 158 adjacent to the second tilted coil antenna 156. In one example, each of the coil antennas 152-158 is operated as a receiver antenna. In other examples, each of the coil antennas 152-158 can be operated as either receiver or transmitter antenna.

A connecting tubular 114 attaches to the upper end (relative to the top of the wellbore) of the second sub 150. A third sub 160 attaches to the upper end of the connecting tubular 114. The third sub 160 is rotatable with respect to its longitudinal axis, and the longitudinal axis can be at an angle with respect to the longitudinal axis of the second sub 150. A first coaxial coil antenna 162 wraps around the lower-most side of the third sub 160. The third sub 160 also includes a first tilted coil antenna 164 positioned above and adjacent to the first coaxial coil antenna 162. The third sub 160 includes a second tilted coil antenna 166 positioned adjacent to the first tilted coil antenna 164. The third sub 160 also includes a third tilted coil antenna 168 adjacent to the second tilted coil antenna 166. In one example, each of the coil antennas 162-168 is operated as a receiver antenna. In other examples, each of the coil antennas 162-168 can be operated as either receiver or transmitter antenna.

A connecting tubular 116 attaches to the upper end (relative to the top of the wellbore) of the third sub 160. A fourth sub 170 attaches to the upper end of the connecting tubular 114. The fourth sub 170 is rotatable with respect to its longitudinal axis, and the longitudinal axis can be at an angle with respect to the longitudinal axis of the third sub 170. A first coaxial coil antenna 172 wraps around the lower-most side of the fourth sub 170. The fourth sub 170 also includes a first tilted coil antenna 174 positioned above and adjacent to the first coaxial coil antenna 172. The fourth sub 170 includes a second tilted coil antenna 176 positioned adjacent to the first tilted coil antenna 174. The fourth sub 170 also includes a third tilted coil antenna 178 adjacent to the second tilted coil antenna 176. In one example, each of the coil antennas 172-178 is operated as a receiver antenna. In other examples, each of the coil antennas 172-178 can be operated as either receiver or transmitter antenna.

Additional details regarding the use of wellbore tools for performing formation resistivity measurements and boundary detection calculations are provided in U.S. Pat. No. 7,659,722, filed Aug. 8, 2007, which is incorporated by reference herein in its entirety.

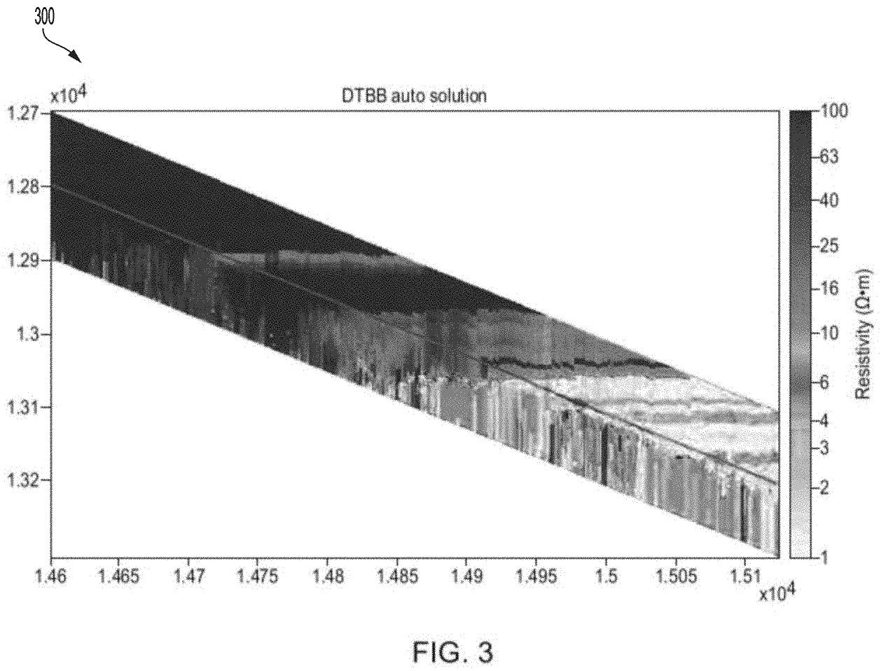

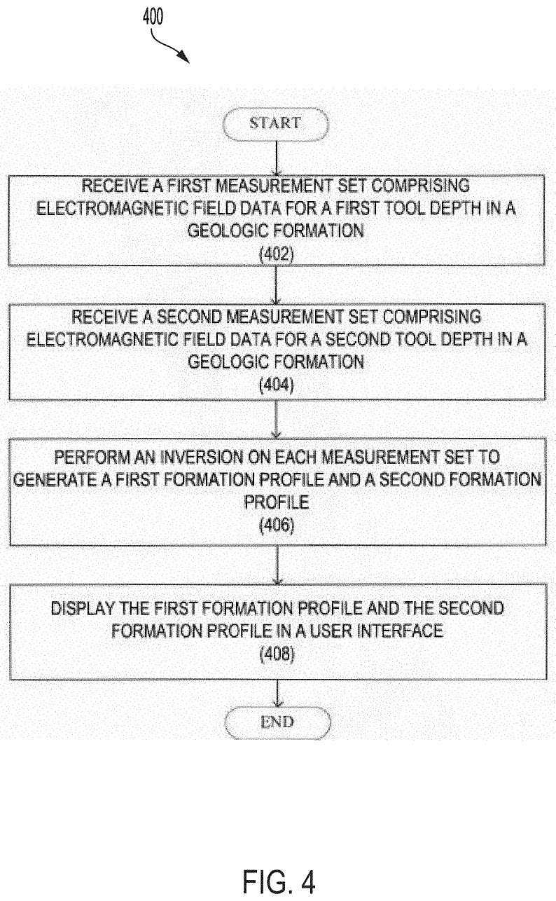

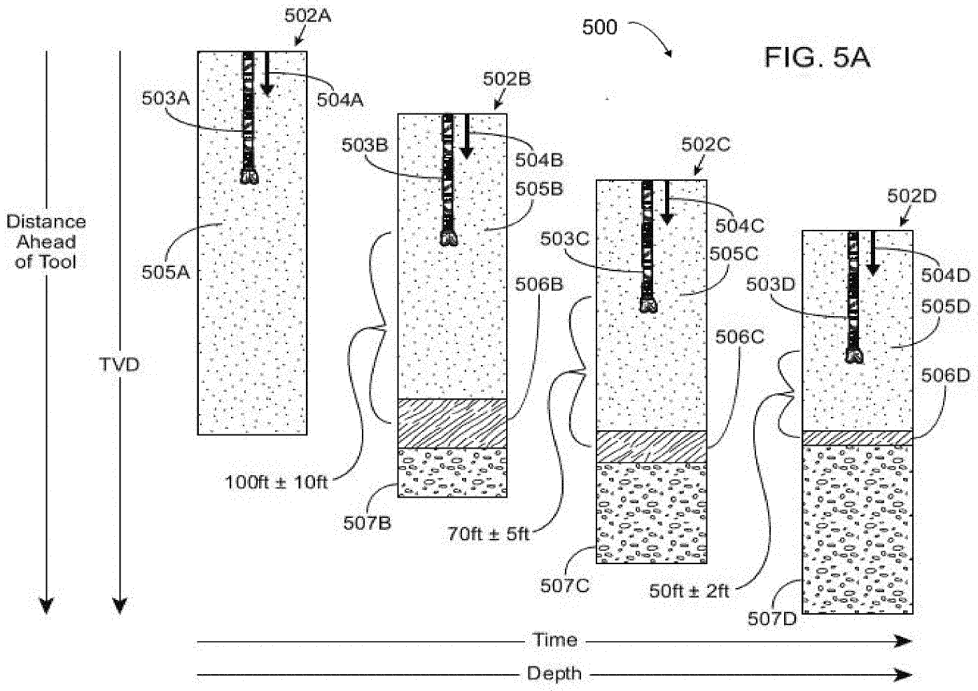

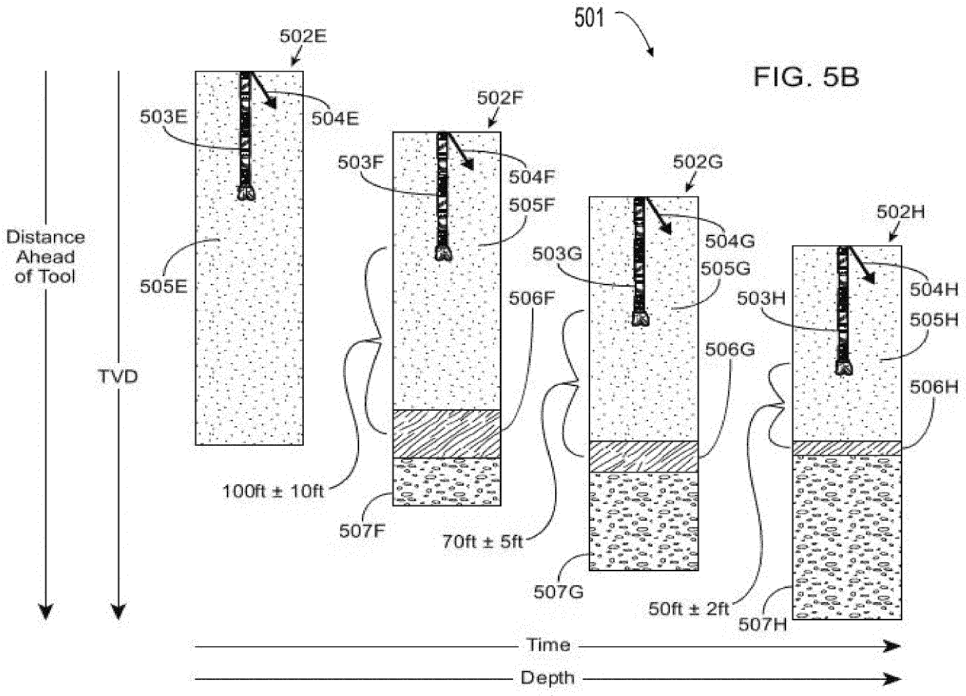

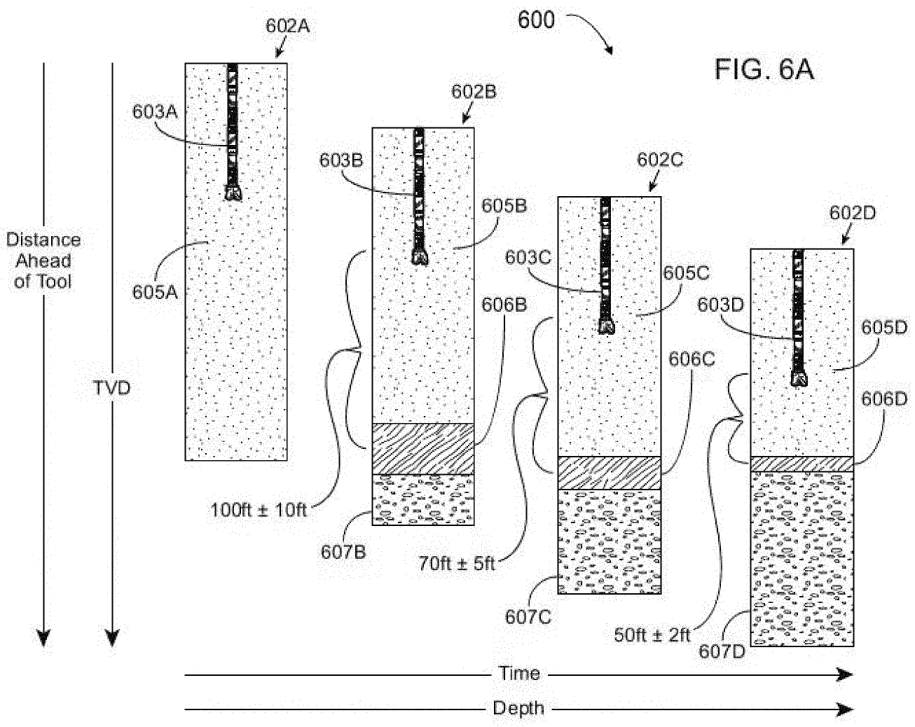

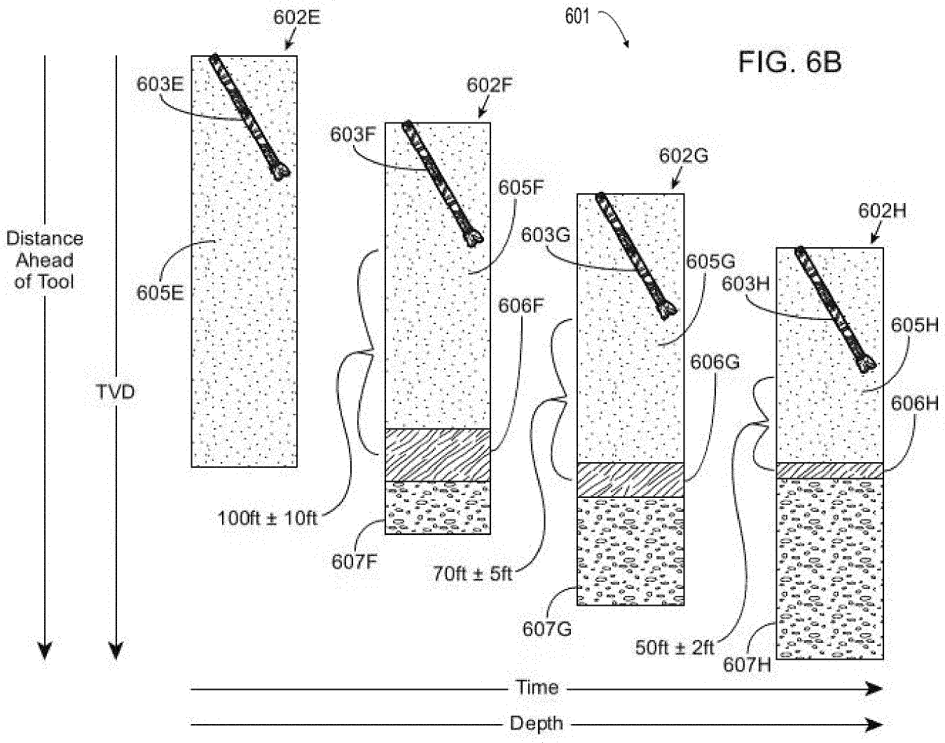

FIG. 3 is an example of a conventional inversion map 300 in which resistivity boundary information is provided with respect to a measurement depth (MD) on the x-axis, and a true vertical depth (TVD) on the y-axis. As illustrated in FIG. 3, conventional inversion map 300 includes a wellbore path indication 302, however, there is no information to visually indicate a distance between a measurement tool and objective boundary layers. Additionally, there is no information to indicate a degree of tool inclination within the wellbore at different depths. Aspects of the disclosed technology provide improved inversion visualizations, as discussed in further detail with respect to FIGS. 5A-6B below. A process for generating improved inversion visualizations in described with respect to FIG. 4.

In particular, FIG. 4 illustrates a process 400 for performing inversion map processing and providing look-ahead inversion visualizations, according to some aspects of the disclosed technology. Process 400 begins with step 402 in which electromagnetic (EM) field data for a first measurement set are received. The received EM field data can include voltage and/or current measurements taken using a resistivity tool, such as tool 100, discussed above with respect to FIG. 2. The first measurement set includes measurement data collected at a first depth along a wellbore path. The path depth can be recorded as a wellbore depth, or as a true vertical depth with respect to the surface, depending on the desired implementation. In some aspects, the measurement set can be associated with a timestamp indicating a time when the EM field data was collected at that particular location in the wellbore path.

In step 404, electromagnetic (EM) field data for a second measurement set are received. The second measurement set includes measurement data collected at a second depth along the wellbore path. In some aspects, the second depth is different from the first depth. For example, a timestamp associated with the second measurement set can indicate a later time at which EM field data was collected in the wellbore, i.e., at a second wellbore position.

In step 406, an inversion is performed on each of the measurement sets to generate corresponding formation profiles. That is, inversion processing is performed on the first measurement set to generate a first measurement profile, and on the second measurement set to generate a second measurement profile. Because each measurement set contains data gathered at a different logging point, the corresponding (inverted) formation profiles can represent resistivity boundaries for vertical slices at each different point.

Inversion processing can include signal processing steps necessary to generate inversion input signals for each measurement set, as well as formation models that match each of the inversion input sets. Once matches for the forward formation models are found, one-dimensional (1D) inversion slices can be generated wherein each 1D inversion provides graphical indications of various formation parameters for the corresponding measurement dataset, including resistivity values and/or boundary locations. Depending on the desired implementation, the inversion approach can utilize deterministic, gradient-based, linear, or non-linear regression algorithms like the Gauss-Newton method, or statistic optimization methods such as the Monte-Carlo or Neural Network methods. In some aspects, the inversion calculation may utilize a combination of computational techniques, such as a combination of deterministic and statistic inversion methods.

Finally, at step 408, the first formation profile and the second formation profile are output, for example, to a user interface (UI) that is provided on a display screen. In some aspects, display of each formation profile can be accompanied by visual indications of tool inclination, a length/size of the current later, and/or a distance to an objective layer. In some aspects, a boundary uncertainty distance (e.g., gap distance) can be displayed with respect to each formation profile. Examples of improved formation profile displays of the disclosed technology with respect to FIGS. 5A-6B, below.

FIGS. 5A and 5B are examples of inversion visualizations that utilize inclination arrows, according to some aspects of the disclosed technology. In both FIGS. 5A and 5B visualizations 500 and 501 provide independent formation profile displays 502 (e.g., 502A, 502B, 502C, and 502D) that are presented with respect to time and measurement depth (MD) on the x-axis, and a true vertical depth (TVD) and distance ahead of the tool, on the y-axis. However, it is understood that other or different variables can be represented on the x, and y-axes, without departing from the scope of the disclosed technology. In all depictions, tool 503 (e.g., 503A, 503B, 503C, and 503D) is shown in a respective current boundary layer 505 (e.g., 505A, 505B, 505C, 505D). Additionally, in each profile display, a degree of tool inclination is indicated by graphical arrows 504 (e.g., 504A, 504B, 504C, and 504D). For example, in formation profile 502A, tool 503A is positioned at its shallowest depth, and indicated to be at a near-vertical inclination by graphical inclination arrow 504A. In this example, tool 503 is shown to maintain a near-vertical inclination throughout its descent as shown in profile display 502B (with arrow 504B), profile display 502C (with arrow 504C), and profile display 502D (with arrow 504D).

In profile display 502A, tool 503A is shown in a current layer 505A, and no other layers are shown, for example, because at this shallow tool depth, no objective layers are being detected. By displaying inversion set as separate formation profiles or formation profile graphics 502 (e.g., 502A, 502B, 502C, and 502D), tool position and inclination can be more intuitively represented. For example, tool distance from a boundary of the current layer can be visualized as a distance from the end of the tool graphic 503 to the bottom of the current layer 505A. Additionally, distances from the tool to an estimated objective layer, including a boundary uncertainty distance, can be represented for each boundary layer graphic, for example, to illustrate how these distances/approximations can change with time and tool depth.

In the example of profile displays 502B, 502C, and 502D, respective objective layers 507 (e.g., 507B, 507C, and 507D) are shown along with boundary uncertainty distances e.g., 506B, 506C, 506D. In these successive formation profile representations corresponding with increasing tool depth, boundary uncertainty distances (506B, 506C, 506D) decrease as tool 503 approaches the boundary of objective layer 507. For example, in profile display 502B, tool 503B is a furthest distance (100 ft) from objective layer 507B, which is associated with the greatest uncertainty (e.g., ±10 ft), whereas in profile display 502D, tool 503D is closer to objective layer 507D (50 ft), and the corresponding boundary uncertainty is smaller (e.g., ±2 ft).

FIG. 5B provides an example visualization 501 in which tool 503 is disposed at a non-vertical inclination. As indicated in profile displays 502E-502H, corresponding graphical arrows 504E-504H provide a visual indication of an amount (degree) of tool 503 inclination. Similar to visualization 500, the example of visualization 501 shows tool 503 (e.g., 503E-503H) in a current layer e.g., 505E-505H, respectively, with similar descent characteristics: as tool 503 approaches objective layer 507, (e.g., 507F-507H, as shown in profile displays 502F-H, respectively), the size (distance) of the boundary uncertainty 506 decreases.

FIGS. 6A and 6B provide visualizations (600, 601, respectively) in which tool inclination is indicated by a displayed angle of the tool graphics 603. Specifically, in FIG. 6A, visualization 600 shows an example in which an inclination of tool 603 is near-vertical, as represented by tool graphics 603A, 603B, 603C, and 603D in profile displays 602A, 602B, 602C, and 602D, respectively Similar to the visualization examples in FIGS. 5A and 5B, tool 603 is shown in a current layer 605 (e.g., 605A-605D), wherein boundary uncertainties 606B, 606C, and 606D (corresponding with profile displays 602B, 602C, and 602D, respectively) decrease as tool 603 TVD increases. By way of example, in formation profile graphic 602B of FIG. 6A, tool 603B is shown to be 100 ft±10 ft from object layer 607B, whereas in formation profile graphic 602D, tool 603D is 50 ft±2 ft from objective layer 607D.

In FIG. 6B, visualization 601 shows an example in which the inclination of tool 603 is at an angle. Specifically, in FIG. 6B, visualization 601 shows an example in which tool 603 is inclined at an angle represented by tool graphics 603E, 603F, 603G, and 603H in profile displays 602E, 602F, 602G, and 602H, respectively. Similar to the examples illustrated by FIGS. 5A and 5B, visualization 600 (FIG. 6A), and visualization 601 (FIG. 6B), both depict examples in which boundary uncertainty decreases as tool 603 approaches a boundary of objective layer 607. That is, boundary uncertainties (606F, 606G, 606H) progressively decrease with depth, as shown in profile displays 602F, 602G, 602H, respectively.

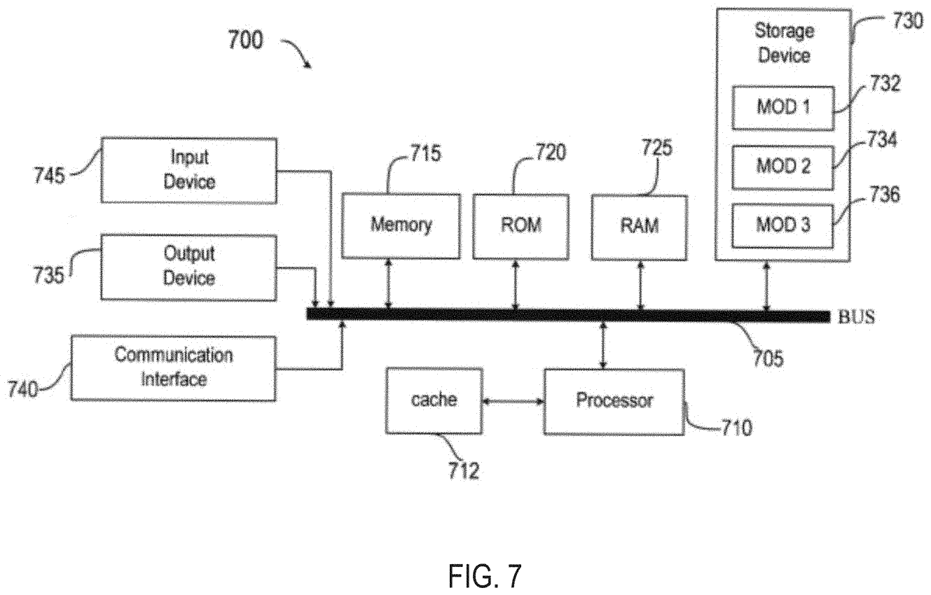

FIG. 7 illustrates an exemplary computing system for use with example tools and systems (e.g., tool 102). The more appropriate embodiment will be apparent to those of ordinary skill in the art when practicing the present technology. Persons of ordinary skill in the art will also readily appreciate that other system embodiments are possible.

Specifically, FIG. 7 illustrates system architecture 700 wherein the components of the system are in electrical communication with each other using a bus 705. System architecture 700 can include a processing unit (CPU or processor) 710, as well as a cache 712, that are variously coupled to system bus 705. Bus 705 couples various system components including system memory 715, (e.g., read-only memory (ROM) 720 and random access memory (RAM) 735), to processor 710. The system architecture 700 can include a cache of high-speed memory connected directly with, in close proximity to, or integrated as part of the processor 710. The system architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. Memory 715 can include multiple different types of memory with different performance characteristics. Processor 710 can include any general-purpose processor and a hardware module or software module, such as module 1 (732), module 2 (734), and module 3 (736) stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system architecture 700, input device 745 can represent any number of input mechanisms, such as a microphone for speech, a touch-sensitive screen for gesture or graphical input, keyboard, mouse, motion input, and so forth. An output device 742 can also be one or more of a number of output mechanisms. In some instances, multimodal systems can enable a user to provide multiple types of input to communicate with the computing system architecture 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer-readable media which can store data that are accessible by a computer, such as magnetic cassettes, flash memory cards, solid-state memory devices, digital versatile disks, cartridges, random access memories (RAMs) 735, read-only memory (ROM) 720, and hybrids thereof.

Storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, output device 742, and so forth, to carry out various functions of the disclosed technology.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general-purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### STATEMENTS OF THE DISCLOSURE

Statement 1: a method for generating a wellbore resistivity map, comprising receiving a first measurement set comprising electromagnetic field data for a first tool depth in a geologic formation, receiving a second measurement set comprising electromagnetic field data for a second tool depth in the geologic formation, performing an inversion on the first measurement set and the second measurement set to generate a first formation profile corresponding with the first measurement set and a second formation profile corresponding with the second measurement set, and displaying the first formation profile and the second formation profile in a user interface (UI), wherein the first formation profile is positioned adjacent to the second formation profile in the UI.

Statement 2: the system of statement 1, wherein the first formation profile and the second formation profile are displayed with respect to a time axis.

Statement 3: the method of any of statements 1-2, wherein the first formation profile and the second formation profile are displayed with respect to a depth axis.

Statement 4: the method of any of statements 1-3, wherein displaying the first formation profile and the second formation profile further comprises displaying an indication of tool inclination with respect to at least one of the first formation profile or the second formation profile.

Statement 5: the method of any of statements 1-4, wherein displaying the first formation profile and the second formation profile further comprises displaying an indication of a boundary uncertainty distance with respect to at least one of the first formation profile or the second formation profile.

Statement 6: the method of any of statements 1-5, wherein displaying the first formation profile and the second formation profile further comprises displaying an indication of a boundary uncertainty distance with respect to at least one of the first formation profile or the second formation profile.

Statement 7: the method of any of statements 1-6, wherein displaying the first formation profile and the second formation profile in the UI, further comprises, displaying an indication of a first boundary uncertainty distance with respect to the first formation profile, and displaying an indication of a second boundary uncertainty distance with respect to the second formation profile, and wherein the first boundary uncertainty distance is different than the second boundary uncertainty distance.

Statement 8: a system for generating a wellbore resistivity map, the system comprising: one or more processors, and a non-transitory memory coupled to the one or more processors, wherein the memory comprises instruction configured to cause the processors to perform operations for receiving a first measurement set comprising electromagnetic field data for a first tool depth in a geologic formation, receiving a second measurement set comprising electromagnetic field data for a second tool depth in the geologic formation, performing an inversion on the first measurement set and the second measurement set to generate a first formation profile corresponding with the first measurement set and a second formation profile corresponding with the second measurement set, and displaying the first formation profile and the second formation profile in a user interface (UI), wherein the first formation profile is positioned adjacent to the second formation profile in the UI.

Statement 9: the system of statement 8, wherein the first formation profile and the second formation profile are displayed with respect to a time axis.

Statement 10: the system of any of statements 8-9, wherein the first formation profile and the second formation profile are displayed with respect to a depth axis.

Statement 11: the system of any of statements 9-10, wherein displaying the first formation profile and the second formation profile further comprises displaying an indication of tool inclination with respect to at least one of the first formation profile or the second formation profile.

Statement 12: the system of any of statements 9-11, wherein displaying the first formation profile and the second formation profile further comprises displaying an indication of a boundary uncertainty distance with respect to at least one of the first formation profile or the second formation profile.

Statement 13: the system of any of statements 9-12, wherein displaying the first formation profile and the second formation profile further comprises displaying an indication of a boundary uncertainty distance with respect to at least one of the first formation profile or the second formation profile.

Statement 14: the system of any of statements 9-13, wherein displaying the first formation profile and the second formation profile in the UI, further comprises displaying an indication of a first boundary uncertainty distance with respect to the first formation profile, and displaying an indication of a second boundary uncertainty distance with respect to the second formation profile, and wherein the first boundary uncertainty distance is different than the second boundary uncertainty distance.

Statement 15: a tangible, non-transitory, computer-readable media having instructions encoded thereon, the instructions, when executed by a processor, are operable to perform operations for receiving a first measurement set comprising electromagnetic field data for a first tool depth in a geologic formation, receiving a second measurement set comprising electromagnetic field data for a second tool depth in the geologic formation, performing an inversion on the first measurement set and the second measurement set to generate a first formation profile corresponding with the first measurement set and a second formation profile corresponding with the second measurement set, and displaying the first formation profile and the second formation profile in a user interface (UI), wherein the first formation profile is positioned adjacent to the second formation profile in the UI.

Statement 16: the tangible, non-transitory, computer-readable media of statement 15, wherein the first formation profile and the second formation profile are displayed with respect to a time axis.

Statement 17: the tangible, non-transitory, computer-readable media of any of statements 15-16, wherein the first formation profile and the second formation profile are displayed with respect to a depth axis.

Statement 18: the tangible, non-transitory, computer-readable media of any of statements 15-17, wherein displaying the first formation profile and the second formation profile further comprises displaying an indication of tool inclination with respect to at least one of the first formation profile or the second formation profile.

Statement 19: the tangible, non-transitory, computer-readable media of any of statements 15-18, wherein displaying the first formation profile and the second formation profile further comprises displaying an indication of a boundary uncertainty distance with respect to at least one of the first formation profile or the second formation profile.

Statement 20: the tangible, non-transitory, computer-readable media of any of statements 15-19, wherein displaying the first formation profile and the second formation profile further comprises displaying an indication of a boundary uncertainty distance with respect to at least one of the first formation profile or the second formation profile.

What is claimed is:

1. A method for generating a wellbore resistivity map, comprising:
receiving a first measurement set comprising electromagnetic field data for a first tool depth in a geologic formation;
receiving a second measurement set comprising electromagnetic field data for a second tool depth in the geologic formation;
performing an inversion on the first measurement set and the second measurement set to generate a first formation profile corresponding with the first measurement set and a second formation profile corresponding with the second measurement set; and
displaying the first formation profile and the second formation profile in a user interface (UI), wherein the first formation profile is positioned adjacent to the second formation profile in the UI.

2. The method of claim 1, wherein the first formation profile and the second formation profile are displayed with respect to a time axis.

3. The method of claim 1, wherein the first formation profile and the second formation profile are displayed with respect to a depth axis.

4. The method of claim 1, wherein displaying the first formation profile and the second formation profile further comprises:
displaying an indication of tool inclination with respect to at least one of the first formation profile or the second formation profile.

5. The method of claim 1, wherein displaying the first formation profile and the second formation profile further comprises:
displaying an indication of a boundary uncertainty distance with respect to at least one of the first formation profile or the second formation profile.

6. The method of claim 1, wherein displaying the first formation profile and the second formation profile further comprises:
displaying an indication of a boundary uncertainty distance with respect to at least one of the first formation profile or the second formation profile.

7. The method of claim 1, wherein displaying the first formation profile and the second formation profile in the UI, further comprises:
displaying an indication of a first boundary uncertainty distance with respect to the first formation profile; and
displaying an indication of a second boundary uncertainty distance with respect to the second formation profile, and wherein the first boundary uncertainty distance is different than the second boundary uncertainty distance.

8. A system for generating a wellbore resistivity map, the system comprising:
one or more processors; and
a non-transitory memory coupled to the one or more processors, wherein the memory comprises instruction configured to cause the processors to perform operations for:
receiving a first measurement set comprising electromagnetic field data for a first tool depth in a geologic formation;
receiving a second measurement set comprising electromagnetic field data for a second tool depth in the geologic formation;
performing an inversion on the first measurement set and the second measurement set to generate a first formation profile corresponding with the first measurement set and a second formation profile corresponding with the second measurement set; and
displaying the first formation profile and the second formation profile in a user interface (UI), wherein the first formation profile is positioned adjacent to the second formation profile in the UI.

9. The system of claim 8, wherein the first formation profile and the second formation profile are displayed with respect to a time axis.

10. The system of claim 8, wherein the first formation profile and the second formation profile are displayed with respect to a depth axis.

11. The system of claim 8, wherein displaying the first formation profile and the second formation profile further comprises:
displaying an indication of tool inclination with respect to at least one of the first formation profile or the second formation profile.

12. The system of claim 8, wherein displaying the first formation profile and the second formation profile further comprises:
displaying an indication of a boundary uncertainty distance with respect to at least one of the first formation profile or the second formation profile.

13. The system of claim 8, wherein displaying the first formation profile and the second formation profile further comprises:
displaying an indication of a boundary uncertainty distance with respect to at least one of the first formation profile or the second formation profile.

14. The system of claim 8, wherein displaying the first formation profile and the second formation profile in the UI, further comprises:
displaying an indication of a first boundary uncertainty distance with respect to the first formation profile; and
displaying an indication of a second boundary uncertainty distance with respect to the second formation profile, and wherein the first boundary uncertainty distance is different than the second boundary uncertainty distance.

15. A tangible, non-transitory, computer-readable media having instructions encoded thereon, the instructions, when executed by a processor, are operable to perform operations for:
receiving a first measurement set comprising electromagnetic field data for a first tool depth in a geologic formation;
receiving a second measurement set comprising electromagnetic field data for a second tool depth in the geologic formation;
performing an inversion on the first measurement set and the second measurement set to generate a first formation profile corresponding with the first measurement set and a second formation profile corresponding with the second measurement set; and
displaying the first formation profile and the second formation profile in a user interface (UI), wherein the first formation profile is positioned adjacent to the second formation profile in the UI.

16. The tangible, non-transitory, computer-readable media of claim 15, wherein the first formation profile and the second formation profile are displayed with respect to a time axis.

17. The tangible, non-transitory, computer-readable media of claim 15, wherein the first formation profile and the second formation profile are displayed with respect to a depth axis.

18. The tangible, non-transitory, computer-readable media of claim 15, wherein displaying the first formation profile and the second formation profile further comprises:
displaying an indication of tool inclination with respect to at least one of the first formation profile or the second formation profile.

19. The tangible, non-transitory, computer-readable media of claim 15, wherein displaying the first formation profile and the second formation profile further comprises:
displaying an indication of a boundary uncertainty distance with respect to at least one of the first formation profile or the second formation profile.

20. The tangible, non-transitory, computer-readable media of claim 15, wherein displaying the first formation profile and the second formation profile further comprises:
displaying an indication of a boundary uncertainty distance with respect to at least one of the first formation profile or the second formation profile.
